(19) United States
(12) Patent Application Publication
(10) Pub. No.: US 2019/0001718 A1
(43) Pub. Date: Jan. 3, 2019

(54) DOOR EXTENSION

(71) Applicant: Hewlett-Packard Development Company, L.P., Houston, TX (US)

(72) Inventors: Michael Kevin Bowen, Vancouver, WA (US); Kevin Lo, Vancouver, WA (US); Thomas W Ruhe, LaCenter, WA (US); Catherine Elizabeth Gould, Vancouver, WA (US); Richard Lee Brinkly, Camas, WA (US); Steve o Rasmussen, Vancouver, WA (US); Raymond C Sherman, Camas, WA (US)

(21) Appl. No.: 16/064,172

(22) PCT Filed: Apr. 7, 2016
(86) PCT No.: PCT/US2016/026475

§ 371 Date: Jun. 20, 2018

(51) Int. Cl. B41J 29/02

(52) U.S. Cl. CPC B41J 29/02

(57) ABSTRACT

This invention relates to a component to modify a door of a printing system including an extension that increases a size of the door and a paper guide attached to the extension; a media handling system including a printing system, a secondary operation device adjacent to the printing system, and a door having an extension; and a door for a media handling system, where the door includes a first media travel path exiting a first exit of the door, a second media travel path exiting a second exit of the door, and a diverter diverting media from the first media travel path to the second media travel path.

### BACKGROUND

Printers and similar devices are often connected into larger systems. For example, scanning, sorting, finishing, fusing, stapling, laminating, or other processes may be performed before, after, or as part of the printing operation. However, selling a system that includes all possible features would increase the price of the system and reduce the total number of sales. Accordingly, many such systems are modular or semi-modular and capable of being expanded or integrated.

Printers and copiers are used by a wide variety of people in an office environment. Some of those people may be technically savvy, while others may have less experience or training to resolve issues that arise in the use of these devices. Accordingly, design of such systems needs to take into account the range of skill levels in the user base. Thus, systems that reduce the number of operations or choices faced by a user when performing a routine task, such as clearing a paper jam or replacing toner offer advantages in the marketplace.

### BRIEF DESCRIPTION OF THE DRAWINGS

The accompanying drawings illustrate various examples of the principles described herein and are a part of the specification. The illustrated examples do not limit the scope of the claims. Throughout the drawings, identical reference numbers designate similar, but not necessarily identical, elements.

FIG. 1 shows a system according to one example consistent with the present disclosure.

FIG. 2 shows a profile view of a door accordingly to one example consistent with the present disclosure.

FIG. 3 shows a profile view of a component according to one example consistent with the present disclosure.

FIG. 4 shows an orthogonal plan view of a component according to one example consistent with the present disclosure.

### DETAILED DESCRIPTION

For purposes of this specification and the associated claims, the term printing system refers to devices capable of handling media and modifying the media. This modification may include deposition of ink, toner, fluids, or other materials onto the media. This modification may also include adjustments to the stiffness of the media, punching material from the media, embossing, guttering, slitting, and similar modifications. The specifics of the media modification processes are not a limiting element.

For purposes of this specification and the associate claims, the term media refers to printing media generally. Accordingly, the term covers paper, polymer sheet, cardboard, and the variety of available print media. The specifics of the media are relevant to the extent that they impact the ability of the system to perform the operations. Thus, the color, specific weight, surface texture, coatings, etc. of the media are likely immaterial to implementing the subject matter of this disclosure.

For purposes of this specification and the associated claims, the term secondary operation device refers to a device used in connection with a printer to provide an additional service to the printer in producing documents. For example, the secondary operation device may provide for scanning, sorting, finishing, punching, fusing, stapling, laminating, or other processes in producing documents.

One commonly encountered failure mode associated with printing systems is the paper jam. A paper jam occurs when media that is traveling through the printing system gets stuck and the printing system is not able to restore the media to track through the desired path. Paper jams have a wide number of contributing factors, including: variation in the media, sticking of sheets of media together, improper alignment, environmental variation, etc. In practice, system design seeks to minimize the number of paper jams, prevent system damage when a paper jam occurs, and facilitate quick and easy clearance of the paper jam and return of the system to operation.

One method that has been used to deal with paper jams has been to include an access door on the printing system to the internal media path. When the system detects a paper jam, the system halts operations and provides an indicator to a user. The indicator may be a message on a display, a blinking light, a noise, a transmitted message such as an email or text, etc. In some cases, the message will indicate which door of a variety of access doors on the system a user can use to access that portion of the system where the paper jam is likely located. A user then opens the respective door and looks for the paper jam.

Hopefully, the user can easily locate and remove the paper jam. Some such doors include a position sensor that allows the system to determine if the door is closed. The system may detect that the jam is cleared or may detect that the door is opened and then closed. The system may restart printing on detecting the jam is cleared to the access door has been used or may wait for a resume command from a user.

Some factors may make clearing a paper jam more difficult. For example, the paper jam may not be easily visible when the door is open. The user may not know which door is associated with the jam or may ignore the notification by the system telling the user where the jam is located. The system may be incorrect and indicate a door that is not properly positioned provide access to clear the jam. The media in the paper jam may be difficult to dislodge or may rip and leave portions behind. The user may need to move or remove a printhead, toner cartridge, or other component in order to access the paper jam. In short, there are a number of design considerations that can make clearing a paper jam a more difficult and frustrating task for a user.

User frustration may produce user dissatisfaction, which is bad for the product and company reputation. Further, user frustration can increase the likelihood that a user will apply excessive force to components while trying to clear the paper jam. This may result in damage or misalignment to components of the system. Accordingly, one design goal is to minimize the frustration a user encounters when clearing a paper jam from the system.

Printing systems include a variety of secondary operation devices to provide additional functionality to the base system. Ideally, media passing into or out of the printing system should transition between the printing system and the secondary operation devices without producing paper jams. However, such transitions also need to be designed to minimize the difficulty in clearing jams when they occur.

The secondary operation devices may include doors of their own to facilitate clearing paper jams within the secondary operation device or between the printing system and the secondary operation device. However, this increases the number of doors confronting a user who needs to clear a paper jam. Because some users will not open the correct door, these additional doors may produce additional frustration for the user in clearing the paper jam.

One approach is to design the door to accommodate attachment of a component. The component includes an extension for the door. The extension covers an opening in the secondary operation device. The extension, being connected to the door, opens with the door. This allows the extension to use the same door position sensor. This also allows a single door to allow access to paper jam clearing areas in both the printing system and the secondary operation device, reducing user frustration as the user can quickly scan and find the paper jam.

The component may be removably attached to the door, for example, with screws. Alternately, the component maybe permanently attached to the door, for example, with one way connections or adhesive.

In one example, the door includes a diverter that routes media away from a second media path in the printing system door to a first media path in the printing system door. The diverter can be actuatable to select between the two paths but programed not to allow passage to the second path unless the secondary operation device is installed. Alternately, the diverter is static and diverts media to the first path. The static diverter may be removably attached to the door. For example, the static diverter may be attached with screws.

The component may use the same screw holes and position on the door as the static diverter allowing quick and reliable change out without adding additional holes or similar mounting locations. In one example, the portions of the door adjacent to the diverter help to support the component. Note that doors that are not designed to have a component attached will not have a first and second media path where the second media path is inaccessible or unused by the printing system alone. Accordingly, providing this unused first path and the static diverter may increase the number of components and costs of the base system. However, incorporating this functionality into the door may be achieved primarily by adjusting the molding of the door's components and provision of the diverter and thus adds little cost while increasing the ability to accommodating the component.

Accordingly, the present specification describes, among other examples, a component to modify a door of a printing system including an extension that increases a size of the door and a paper guide attached to the extension. In some versions, the component also includes a dynamic diverter.

The present specification also describes a media handling system that includes: a printing system; a secondary operation device adjacent to the printing system; and a door having an extension. The door provides access to both the printing system and the secondary device to clear paper jams. The door includes a diverter that distributes media to the printing system and the secondary operation device.

The present specification also describes a door for a media handling system, where the door includes: a first media travel path exiting a first exit of the door; a second media travel path exiting a second exit of the door; and a diverter diverting media from the first media travel path to the second media travel path.

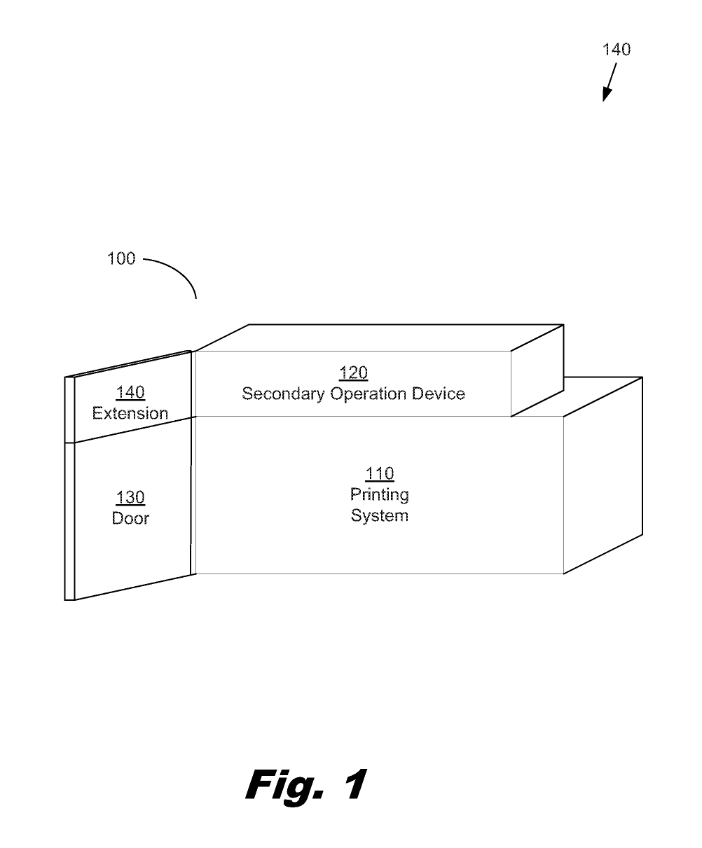

FIG. 1 shows a system according to one example consistent with the present disclosure. The system (100) comprises: a printing system (110), a secondary operation device (120), a door (130), and an extension (140). The door and extension move together and seal openings in the printing system (110) and the secondary operation device (120) when the door (130) is closed. When open, the door (130) and door extension (130) move out of the way to allow access to the inner portions of the printing system (110) and the secondary operation device (120). This allows a user to clear a paper jam associated with either the printing system (110) or secondary operation device (120). Once the paper jam has been cleared, the door (130) and door extension (140) close by applying force to either the door (130) or the door extension (140).

The printing system (110) includes at least one door (130) that is used to access the inside of the printing system. The door (130) allows a user to clear a paper jam or access components for servicing or replacement. The printing system (130) includes at least one media traveling path that moves media from the printing system to the door (130). The use of the door (130) as part of the media traveling path may allow reduction in the size of the printing system (110).

The system (100) includes a number of media traveling paths. These are routes through the system which move media through the system and through various operations. Media traveling paths include guides, diverters, rollers, pickups, and similar elements to produce controlled movement of the media. For example, the speed of the media passing through a printing element may be tightly controlled to assure proper spacing between dots. Movement through other elements may accommodate controls with greater or lesser degrees of precision. For example, passage through a fuser may be more robust to the speed of the media. In some cases, there are design tradeoffs between media handling parameters and the operation of the functional units of the system. Increasing the size and complexity of the media handling components may increase their control over the movement of media through the system (100) while also increasing the number of parts, cost, and size of the system. The inclusion of the door (130) as part of the media traveling paths can reduce the size, cost, and number of parts in the system (100). Thus, efficient design makes use of the door (130) space of the printing system (110) and the secondary device (120).

Media traveling paths may also be used to modify the positioning or orientation of the media. For example, a looped path may allow the printing system (110) to print one side of a piece of media and then print the opposite side by inverting the media using the printing path. Thus, the design and implementation of media traveling paths can increase the functionality of the components of the system (100).

The secondary operation device (120) performs some function that is not performed by the printing system (110) or otherwise augments the capabilities of the printing system (110). This augmentation can include a second printer such that that the total throughput is increased. The secondary operation device (120) is not included with the printing system (110) so as to allow customization and reduce the cost of the basic printing system (110). The secondary operation device (120) is functionally connected to the printing system by a media traveling path. The media traveling path may be directly between the printing system (110) and the secondary operation device (120). The media traveling path may go from the printing system (110) through the door (130) to the secondary operation device (120). The media traveling path may go from the printing system (110) to the door (130) to the extension (140) to the secondary operation device (120). There may be more than one media traveling path between the secondary operation device (120) and the printing system (110). A given media traveling path may be used to send media in both directions between the printing system (110) and secondary operation device (120).

Some non-limiting examples of secondary operation devices (120) include: media storage bins, printers, coating devices, and finishers. The secondary operation device (120) may be mounted above the printing system (110). The secondary operation device (120) may be mounted below the printing system (110). The secondary operation device (120) may be mounted adjacent to the printing system (110), for example on the right or left side. These different configurations allow the door (130) and extension (140) to allow access to the printing system (110) and the secondary operation device (120) simultaneously.

The door (130) is attached to the printing system (110). The door (130) may operate on a hinge. The door (130) may operate on a slide. The door (130) provides access to the interior of the printing system (110).

The door (130) may have an associated sensor. The sensor may detect when the door (130) is closed. The sensor may detect when the door (130) is open. The sensor may detect the position of the door (130). The information provided by the sensor may be used to provide a message to a user about the state of the door (130). Such a message may include a light, a sound, a displayed message on a display, an electronic message transmitted by a network, etc. The door (130) may include a plurality of sensors. A sensor may be used to identify the presence of media in a portion of a media travel path. For example, a sensor may include an optical sensor on one side of the media travel path and a light source, e.g. a light emitting diode (LED), on the other side of the media travel path. In another example, a single LED may support a plurality of optical sensors, such as one above and a second below the LED. A sensor may allow determination of the speed of a sheet of media. Such a sensor may allow detection of the location of jammed media. Information from the sensor may be used to provide a message to a user about the location of jammed media or to provide instructions to aid the user in clearing the paper jam.

The door (130) may include functional elements to assist in processing or routing media through the system (100). The door (130) may include a motor to move parts attached to the door (130). For example, the door (130) may include rollers to move media along a media travel path. The door (130) may receive mechanical motion from the printing system to move parts attached to the door (130). For example, the door (130) may include a gear, belt, or friction wheel that interfaces with the printing system (110) to control rollers. Power for a component on the door (130) can be obtained from the printing system (110). Power for a component on the door (130) can be obtained from the secondary operation device (120). Power for a component on the door can be obtained indirectly from the secondary operation device (130) through the extension (140).

The door (130) may include a diverter capable of routing media from a first media travel path to a second media travel path. In some examples, the diverter is actuatable to allow selection between multiple media travel paths depending on a signal. In one example, the diverter includes a recoil mechanism, such as a spring, and an actuator, to allow selection of the desired media travel path. The diverter may be a fixed diverter and not be capable of selecting between two different media travel paths but rather always redirects the media to one media travel path. In the case of a fixed diverter, actuators and/or recoil mechanisms may not be included.

The extension (140) extends the size of the door to accommodate the secondary operation device (120) as well as the printing system (110). The extension (140) is attached to the door (130). The extension may be permanently attached to the door, for example, using adhesive or one-way connections. The extension may be removably attached to the door, for example, using screws, bolts and nuts, or similar reversible devices.

The portion of the door (130) that interacts with the extension (140) may be located on the top, bottom, side, front, and/or back of the door (130) depending on the relative placement of the secondary operation device (120) and the printing system (110). The door (130) may include mechanical features to facilitate attachment to of the extension (140) to the door. The door (130) may include holes, ribs, protrusions, and similar elements to stabilize the extension (140) relative to the door (130). The features may be covered by a removable facade, which is removed prior to attachment of the door (130). Such a removable facade may improve the aesthetics of the door (130) when the printing system does not have a secondary operation device (120). In one example, the extension (140) includes a pin to interact with a hinge between the door (130) and the printing system (110). The extension (140) may include a cup that encircles a portion of the hinge between the door (130) and the printing system (110) to stabilize the extension (140) relative to the door (130).

The door (130) may include a metal plate and/or strip to strengthen the connection between the door (130) and the extension (140). A metal plate and/or strip may connect to both the extension (140) and the door (130) to stabilize them relative to each other and/or increase rigidity of the extension (140).

In one example, the extension is installed by removing a component attached to the door (130) and installing the extension (140) in the place of the removed component. The removed component may be a fixed diverter that redirects from a media travel path to the extension to a media travel path to the printing system (110). The extension may include a dynamic diverter to facilitate the use of both media travel paths and allowing routing to the secondary operation device (120) either directly or through the extension (140). The installed extension (140) may use screw holes or other connections associated with the removed component. This simplifies change out and reduces the likelihood of incorrect installation. The use of pre-existing attachment points also may allow reuse of the same connectors (e.g. screws), reducing the number of parts in the extension kit and waste.

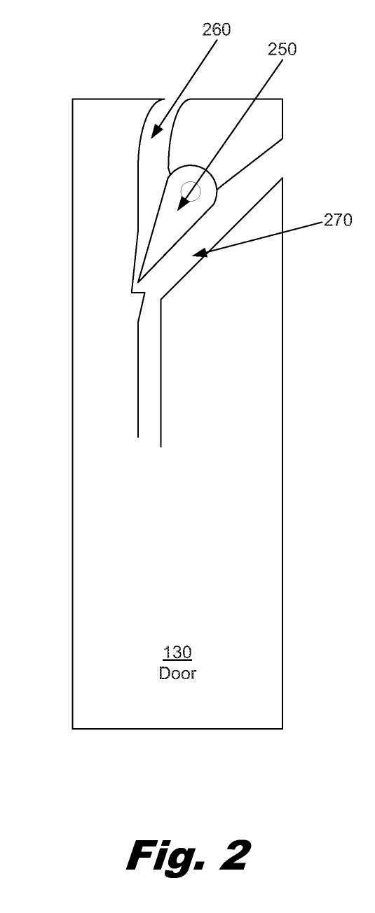

FIG. 2 shows a profile view of the door (130) with the two media travel paths. The first media travel path (260) exits to either the extension (140) or the secondary operation device (120). The second media travel path (270) exits to the printing system (110). The first media path is unused until the extension (140) and/or secondary operation device (120) are installed, like an off-ramp that is never connected into the highway system. In one example, a fixed diverter (250) is in place between the two media travel paths (260, 270) such that all media is sent to the second path. In another example, an actuatable diverter (250) is in place between the two media travel paths (260, 270) and the actuatable diverter (250) is kept in position to direct output to the second media travel path (270) whenever media reaches the diverter (250) until the secondary operation device (120) and/or the extension (140) is installed. If the actuatable diverter (250) includes a restoration mechanism and an actuator, then this can be accomplished by not actuating the mechanism. The actuating mechanism may not be powered until installation of the extension (140) or the secondary operation device (120). For example, the actuator may be connected to a power source upon installation of the extension (140) or the secondary operation device (120).

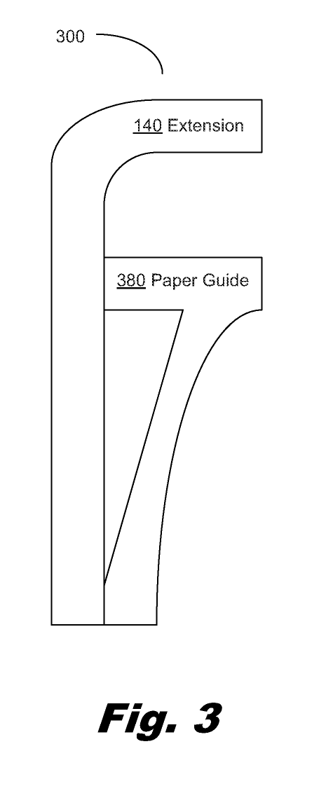

FIG. 3 shows a profile view of a component (300) according to one example consistent with the present disclosure. The component (300) includes an extension (140) and a paper guide (380) attached to the extension (140).

The extension (140) serves to increase the size of the door (130) so that the combination of the door (130) and the extension (140) serve as a single door to both the printing system (110) and the secondary operation device (120). This reduces the number of doors on the combined system, which in turn reduces the number of doors that can be opened while clearing a paper jam.

The extension (140) can be formed of any suitable material. Preferably the extension (140) coordinates its appearance with the door (130) so as to present a unified look and feel. The extension (140) may be formed of injection molded polymer, for example, polyvinylchloride (PVC), polyethylene terephthalate (PET), polyurethane (PU), polyimide (PI), and/or polystyrene (PS). Alternately, a composite may be used, for example, a glass or fiber reinforced polymer. Metals and wood may similarly be used although the associated cost is a consideration. Ceramics could be made to function but are vulnerable to damage.

The extension (140) may include a handle or gripping location to encourage users to open the door (130) and extension (140) at a given location. A handle or gripping location may be present on the door (130).

The extension (140) may include a number of features to facilitate attachment to the door (130). The extension (140) may include projections or recessed features to interlock with the door (130). The extension (140) may include pins or holes to receive pins to connect to the door (130).

The extension (140) may include a metal plate to increase its rigidity. The extension (140) may use ribs or other features to increase its rigidity. These features may be incorporated into the paper guide (380) or be separate. For example, the guide features of the paper guide (380) may also serve as ribs to increase the rigidity of the extension (140).

The paper guide (380) directs media received from the first media traveling path (260) to a feed location for the secondary operation device (120). The media guide (380) may be integrally molded with or over molded onto the extension (140). The media guide may be formed separately and attached mechanically with fasteners, heat welded, adhered, interlocked and/or similarly connected to the extension (140). In one example, the media guide (380) may be also attached to the door (130) as part of the installation process and thus may serve to reinforce the joint between the door (130) and the extension (140).

In one example, the media guide (380) includes a plurality of ribs which contact the moving media along their length. This reduces the overall material cost and weight of the guide. This approach also reduces the friction between the guide and the media. The profile of the paper guide (380) redirects the media to the desired location, facilitating hand off between the paper guide (380) and the secondary operation device (120).

The extension (140) may include a roller associated with the paper guide to push the media towards and/or away from the second operation device (120). The roller may be limited to turning in a single direction. The roller may turn in either direction depending on a control signal. There may be a plurality of rollers. The rollers may be powered by a motor attached to the extension (140). The rollers may be powered by a motor located on the door (130). The rollers may be powered by a motor located in the secondary operation device (120). The rollers may be powered by a motor located in the printing system (110). A mechanical couple, gear, belt, friction wheel, and/or similar device may be used to transmit mechanical energy to control the rotation of the roller. The speed and direction of the roller may be controlled.

The extension (140) may include a sensor to monitor the position and/or speed of media passing through the extension (140) along the paper guide (380). The component (300) may include a power connection to the door (130), the secondary operation device (120), and/or the printing system (110). The power connection may power the sensor, a motor, a signal source, and/or other devices attached to the extension (140).

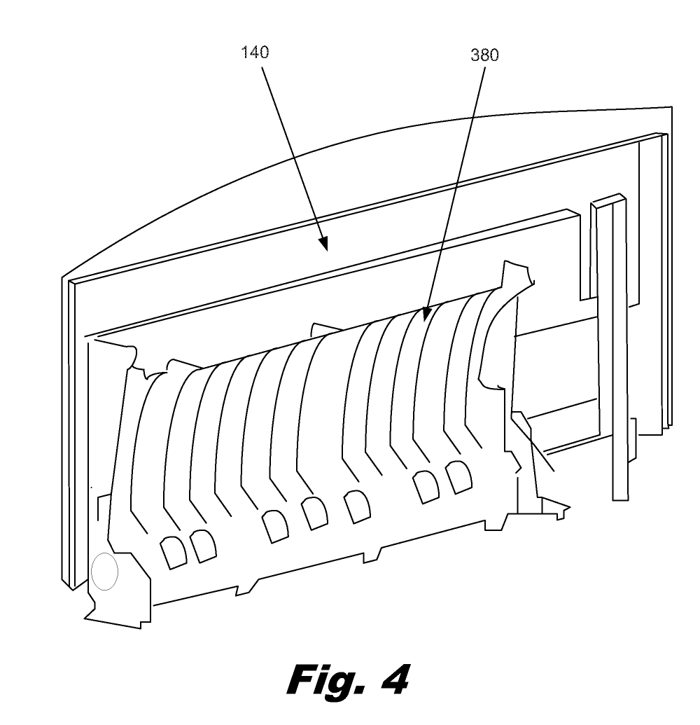

FIG. 4 shows an orthogonal CAD drawing of a component (300) according to one example consistent with the present disclosure. The drawing shows the extension (140) and the paper guide (380). Connection features to facilitate attachment to the door (130) are visible along the bottom of the extension (140). Rollers are visible at the base of the paper guide (380) to help move the media upward. Connections to receive mechanical motion to move the rollers are visible on either side of the roller axis. A stiffening element is also visible along the right side of the extension (140). Features are formed along the top and sides of the extension (140) to facilitate closing against the secondary operation device (120).

Within the principles described by this specification, a vast number of variations exist. The examples described are examples, and are not intended to limit the scope, applicability, or construction of the claims.

What is claimed is:

1. A component to modify a door of a printing system, the component comprising:
an extension that increases a size of the door and
a paper guide attached to the extension.

2. The component of claim 1, wherein the paper guide comprises a roller.

3. The component of claim 2, wherein the component further comprises a motor to rotate the roller.

4. The component of claim 3, wherein the component further comprises a power cord to provide power to the motor.

5. The component of claim 4, wherein the roller receives mechanical motion from at least one of: a secondary operation device, the door, and the printing system.

6. The component of claim 1, wherein the component is attached to the door of the printing system using screws.

7. The component of claim 1, wherein a part attached to the door is removed prior to installation of the component.

8. The component of claim 7, wherein the component is compatible with an attachment location of the part removed from the door prior to installation of the component.

9. The component of claim 1, wherein the extension covers an opening of a secondary operation device.

10. The component of claim 1, wherein the component is removably attachable to the door.

11. The component of claim 1, wherein a sensor on the printing system indicates a position of the extension.

12. A media handling system comprising:
a printing system;
a secondary operation device adjacent to the printing system; and
a door comprising an extension, wherein the door provides access to both the printing system and the secondary device to clear paper jams and the door comprises a diverter that distributes media to the printing system and the secondary operation device.

13. The system of claim 12, wherein the diverter comprises an actuator responsive to a signal.

14. A door for a media handling system, the door comprising:
a first media travel path exiting a first exit of the door;
a second media travel path exiting a second exit of the door; and
a diverter diverting media from the first media travel path to the second media travel path.

15. The door of claim 14, wherein the diverter is a fixed diverter.
